(19) United States
(12) Patent Application Publication
(10) Pub. No.: US 2009/0068897 A1
(43) Pub. Date: Mar. 12, 2009

(54) Slot connector

(76) Inventor: Zuofeng Jin, Qingyang City (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 12/230,810

(22) Filed: Sep. 5, 2008

(30) Foreign Application Priority Data
Sep. 6, 2007 (CN) 200710030124.4

(51) Int. Cl. H01R 24/00

(52) U.S. Cl. 439/637

(57) ABSTRACT

A slot connector includes: a lengthwise insulating body, an upper row of conductive terminals and a lower row of conductive terminals. The insulating body is provided with a lengthwise slot for receiving an electric card. The upper and lower sides of the slot are provided with a receiving groove for receiving the conductive terminals respectively. At least one receiving groove for receiving the conductive terminals is provided with a second abutting block. The lower row of conductive terminals extends to form a second abutting portion from its contacting portion along the inside of the slot. When the contacting portion of the lower row of conductive terminals is compressed, the second abutting portion abuts the second abutting block on the insulating body and slides with respect to the second abutting block so that the second abutting portion can provide a supporting force to the contacting portion.

### BACKGROUND OF THE INVENTION

1. Field of the Invention

The present invention relates to an electrical connector, and in particular to a slot connector provided with a lengthwise slot.

2. Description of Related Art

FIG. 1 and FIG. 2 are schematic views showing a prior art slot connector being assembled with an electric card. The slot connector b1 includes an upper row of conductive terminals b22, a lower row of conductive terminals b11, and an insulating body b10 for receiving the upper and lower rows of conductive terminals b22, b11. The upper row of conductive terminals b22 are each provided with an elastic arm b221. A contacting portion b223 is provided to protrude from a distal end of the elastic arm b221. The lower row of conductive terminals b11 are also each provided with an elastic arm b112. A contacting portion b114 is provided to protrude from the elastic arm b112. The contacting portion b114 is provided with an abutting arm b113 extending toward the inside of the slot. The insulating body b10 is provided with a slot b10 for receiving an electric card b2. The inside of the slot b100 is provided with a platform b102. After the electric card b2 is inserted into the slot b100 to contact the contacting portions b223 of the upper row of conductive terminals b22 and the contacting portions b114 of the lower row of conductive terminals b11, a user can press and rotate the electric card b2. At this time, the contacting portions b114 are compressed by the electric card b2 to slide downwards with respect to the electric card b2. Furthermore, the elastic arms b112 of the lower row of conductive terminals b11 will be deformed elastically. The abutting arms b113 of the lower row of conductive terminals b11 move downwards to abut on the platform b102. However, such a slot connector b1 has drawbacks as follows. Since the extending direction of the distal ends of the elastic arms b221 of the upper row of conductive terminals b22 is opposite to the insertion direction of the electric card b2, so that while inserting the electric card b2 into the slot connector, the upper row of conductive terminals b22 may snap easily due to improper insertion angle or excessive inserting force. Furthermore, after the electric card b2 is pressed to a specific position for fixation, due to the manufacturing tolerance of the lower row of conductive terminals b11, not all the abutting arms b113 may contact the platform b102. Therefore, some of the abutting arms b113 contacting the platform b102 can provide a supporting force to the contacting portions b114, while the other abutting arms b113 not contacting the platform b102 cannot provide a supporting force, which causes a difference in the contact degree between the electric card b2 and the contacting portions b114. As a result, the impedances among the lower row of conductive terminals b11 are different, which affects the high-frequency property of the slot connector b1. At the same time, an oxidation layer on a portion of the contacting portions b114 cannot be scraped off by means of the sliding movement with respect to the electric card b2 due to the difference in the contact degree, so that the electrical connection of the slot connector b1 will be affected.

Therefore, it is necessary to design a novel slot connector to overcome the above-mentioned drawbacks.

### SUMMARY OF THE INVENTION

The object of the present invention is to provide a slot connector for connecting with an electric card, whereby the snapping of conductive terminals can be prevented and the contact degrees between the contacting portions of the conductive terminals and the electric card can be made the same.

In order to achieve the above objects, the present invention provides a slot connector, which includes: a lengthwise insulating body, an upper row of conductive terminals and a lower row of conductive terminals. The insulating body is provided with a lengthwise slot along its longitudinal direction for receiving an electric card. The upper and lower sides of the slot are provided with a plurality of receiving grooves for receiving the upper and lower rows of conductive terminals respectively. The upper and lower rows of conductive terminals are provided with contacting portions that respectively face each other but are not located on the same vertical line (e.g. contacting portions respectively face each other and are staggered in parallel). The two contacting portions are provided along an opening of the slot with an outwards-inclining guiding portion respectively. The two guiding portions form an opening with a gradually increasing width for guiding the electric card. The two guiding portions are provided with a bending portion respectively. At least one bending portion extends inversely to form an elastic arm. The elastic arm is bent and extended to form a first connecting portion perpendicular to the longitudinal direction of the insulating body. The end of the first connecting portion away from the elastic arm is provided with a soldering portion. The two contacting portions are provided with a second connecting portion along the inside of the slot respectively.

In comparison with the prior art in this field, according to the slot connector of the present invention, two contacting portions are respectively provided with an outwards-inclining guiding portion along the opening of the slot. The two guiding portions form an opening with a gradually increasing width for guiding the electric card, so that an electric card can be guided into the slot efficiently. The two guiding portions extend to form a bending portion respectively. At least one bending portion extends inversely to form an elastic arm, so that the conductive terminals can provide better elasticity when compressed. The two contacting portions are provided with a second connecting portion along the inside of the slot respectively, so that the distal ends of the two contacting portions of the conductive terminals extend toward the inside of the slot. Thus, the extending direction of the conductive terminals is identical to the insertion direction of the electric card, so that the snapping of terminals caused by unbalanced force or improper insertion angle can be avoided upon the insertion of the electric card.

The present invention further provides a slot connector, which includes: a lengthwise insulating body, an upper row of conductive terminals and a lower row of conductive terminals. The insulating body is provided with a lengthwise slot along its longitudinal direction for receiving an electric card. The upper and lower sides of the slot are provided with a plurality of receiving grooves for receiving the upper and lower rows of conductive terminals respectively. At least one receiving groove receiving the lower row of conductive terminals is provided with a second abutting block. The upper and lower rows of conductive terminals are provided with contacting portions that respectively face each other but are not located on the same vertical line (e.g. the contacting portions respectively face each other and are staggered in parallel). The two contacting portions are provided along an opening of the slot with an outwards-inclining guiding portion respectively. The two guiding portions form an opening with a gradually increasing width for guiding the electric card. The two guiding portions extend to form a bending portion respectively. The lower row of conductive terminals extends from the corresponding contacting portion along the inside of the slot to form a second abutting portion. The second abutting portion is provided on the side opposite to the contacting surface between the contacting portion and the electric card. When the contacting portions of the lower row of conductive terminals are pressed, the second abutting portion abuts the second abutting block of the insulating body and slides with respect to the second abutting block.

In comparison with the prior art in this field, according to the slot connector of the present invention, two contacting portions are respectively provided with an outwards-inclining guiding portion along the opening of the slot. The two guiding portions form an opening with a gradually increasing width for guiding the electric card, so that an electric card can be guided into the slot efficiently. The lower row of conductive terminals extends from the corresponding contacting portion along the inside of the slot to form a second abutting portion. The second abutting portion is provided on the side opposite to the contacting surface between the contacting portion and the electric card. When the contacting portions of the lower row of conductive terminals are pressed, the second abutting portion abuts the second abutting block of the insulating body and slides with respect to the second abutting block. Thus, the second abutting portion can provide a supporting force to the contacting portion. Furthermore, the second abutting portion is not restricted by the downward movement, so that each conductive terminal in the lower row can abut on the second abutting block after being pressed to a certain degree. As a result, the contact degrees between each conductive terminal in the lower row and the electrical card are the same, so that the impedances between each conductive terminal are the same, thereby satisfying and maintaining the high-frequency property of the slot connector. At this time, the oxidation layer on the contacting portion can be scraped off by means of the sliding movement with respect to the electric card, thereby guaranteeing the electrical connection between the slot connector and the electrical card.

The present invention further provides a slot connector, which includes: a lengthwise insulating body, an upper row of conductive terminals, and a lower row of conductive terminals. The insulating body is provided with a lengthwise slot along its longitudinal direction for receiving an electric card. The upper and lower sides of the slot are provided with a plurality of receiving groove for receiving the upper and lower rows of conductive terminals respectively. The upper and lower rows of conductive terminals are provided with contacting portions that respectively face each other but are not located on the same vertical line (e.g. the contacting portions respectively face each other and are staggered in parallel). The two contacting portions are provided along the inside of the slot with a first abutting portion respectively for abutting the insulating body. The contacting portions of the lower row of conductive terminals extend to form bending portions. The bending portions extend to form horizontal positioning portions.

In comparison with the prior art in this field, according to the slot connector of the present invention, two contacting portions are provided along the inside of the slot with a first abutting portion respectively for abutting the insulating body. Therefore, the distal ends of the two contacting portions of the conductive terminals extend toward the inside of the slot. Thus, the extending direction of the conductive terminals is identical to the insertion direction of the electric card, so that the snapping of terminals caused by unbalanced force or improper insertion angle can be avoided upon the insertion of the electric card. Furthermore, the contacting force between the contacting portions and the electric card can be increased. As a result, the contact degrees between each contacting portion and the electrical card are the same, so that the impedances between each conductive terminal are the same, thereby satisfying and maintaining the high-frequency property of the slot connector. At this time, the oxidation layer on the contacting portion can be scraped off by means of the sliding movement with respect to the electric card, thereby guaranteeing the electrical connection between the slot connector and the electrical card.

### BRIEF DESCRIPTION OF THE DRAWINGS

FIG. 1 is a schematic view showing a slot connector of prior art before an electric card is inserted;

FIG. 2 is a schematic view showing a slot connector of prior art after an electric card is inserted;

FIG. 3 is an exploded perspective view showing the insulating body and the upper and lower rows of conductive terminals according to the slot connector of the present invention;

FIG. 4 is an assembled view showing the insulating body and the upper and lower rows of conductive terminals according to the slot connector of the present invention;

FIG. 5 is a partially enlarged view showing the insulating body of the slot connector of the present invention;

FIG. 6 is a partially enlarged view showing the insulating body of FIG. 5 along another direction;

FIG. 7 is a partial view showing the upper and lower rows of conductive terminals being assembled with the insulating body;

FIG. 8 is a cross-sectional view showing the upper and lower rows of conductive terminals being assembled with the insulating body, along the positions of the conductive terminals;

FIG. 9 is a schematic view showing the slot connector of FIG. 8 being inserted by an electric card;

FIG. 10 is a schematic view showing the slot connector of FIG. 8 after being inserted by an electric card;

FIG. 11 is a partial perspective view showing separating ribs between adjacent terminals of the slot connector of the present invention before deformation;

FIG. 12 is a partial perspective view showing separating ribs between adjacent terminals of the slot connector of the present invention after deformation;

FIG. 13 is a partial perspective view showing separating ribs between adjacent terminals of the slot connector of the present invention after deformation along another direction;

FIG. 14 is an assembled perspective view showing the second embodiment of the slot connector of the present invention;

FIG. 14A is a cross-sectional magnification of the assembled perspective view showing the second embodiment of the slot connector of the present invention;

FIG. 15 is a schematic view of FIG. 14 along another direction;

FIG. 15A is a cross-sectional magnification of the schematic view of FIG. 14 along another direction;

FIG. 16 is an exploded and staggered cross-sectional view showing the conductive terminals and the insulating body according to the second embodiment of the slot connector of the present invention;

FIG. 17 is an assembled and staggered cross-sectional view showing the conductive terminals and the insulating body according to the second embodiment of the slot connector of the present invention;

FIG. 18 is a cross-sectional view along the line A-A showing the second embodiment of slot connector of the present invention being inserted by the electric card; and

FIG. 19 is a cross-sectional view along the line A-A showing the second embodiment of slot connector of the present invention being fixed by the electric card.

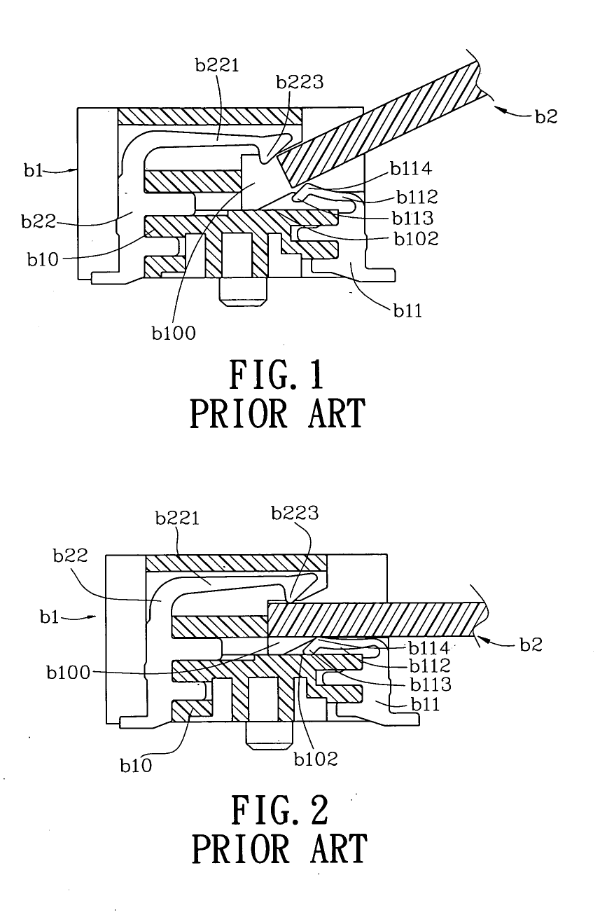

### DETAILED DESCRIPTION OF PREFERRED EMBODIMENTS

The slot connector of the present invention will be further described with reference to the accompanying drawings.

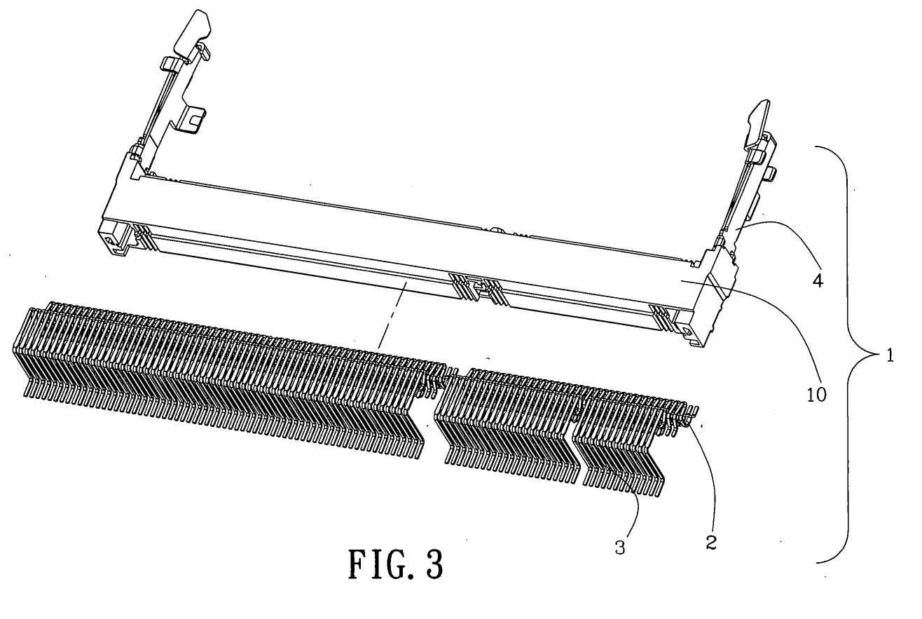

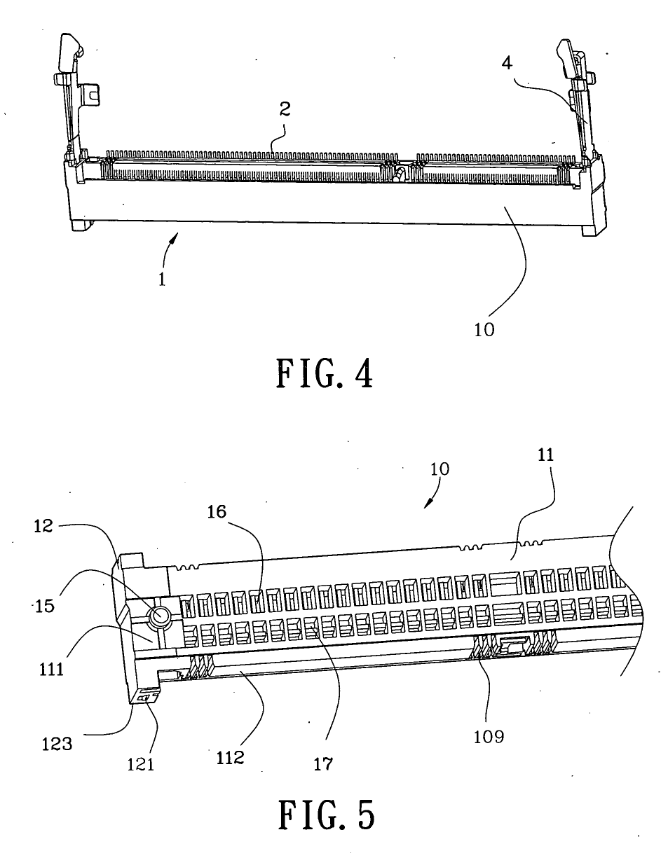

Please refer to FIGS. 3 and 4. The present invention provides a slot connector 1, which includes an insulating body 10, an upper row of conductive terminals 3, a lower row of conductive terminals 2, and two metallic latches 4.

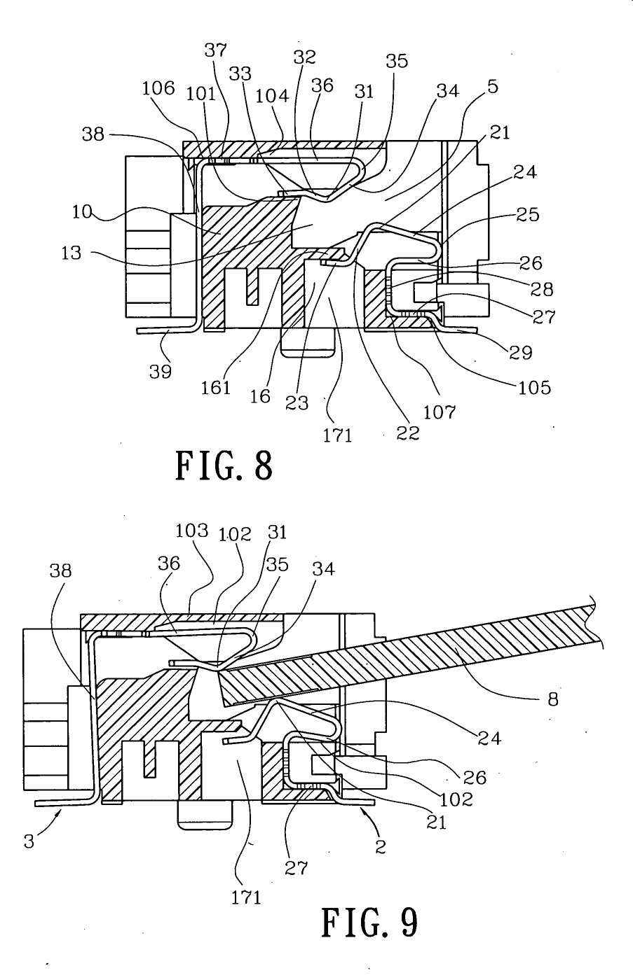

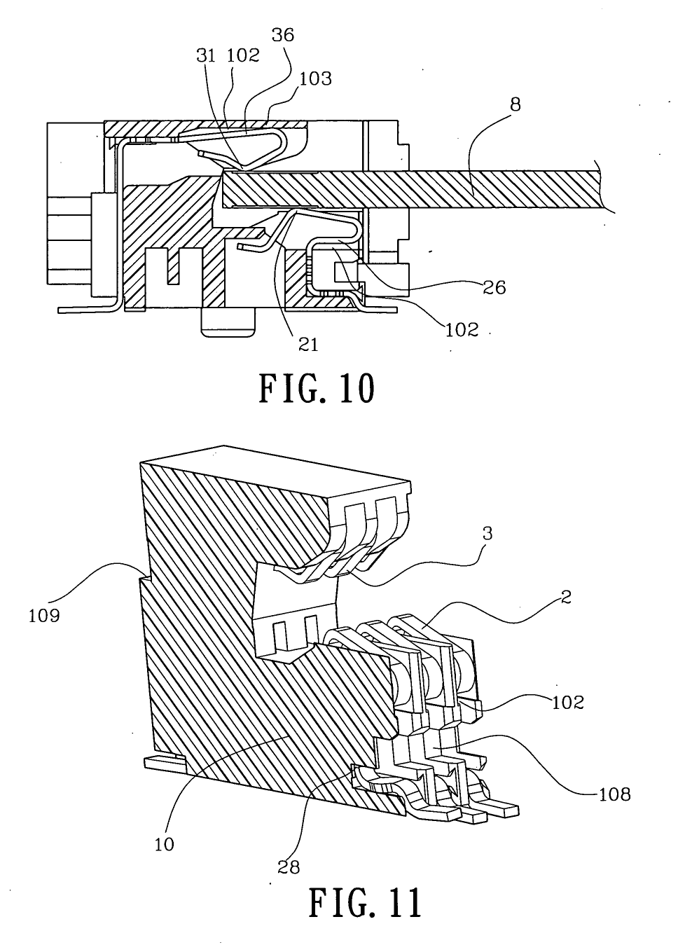

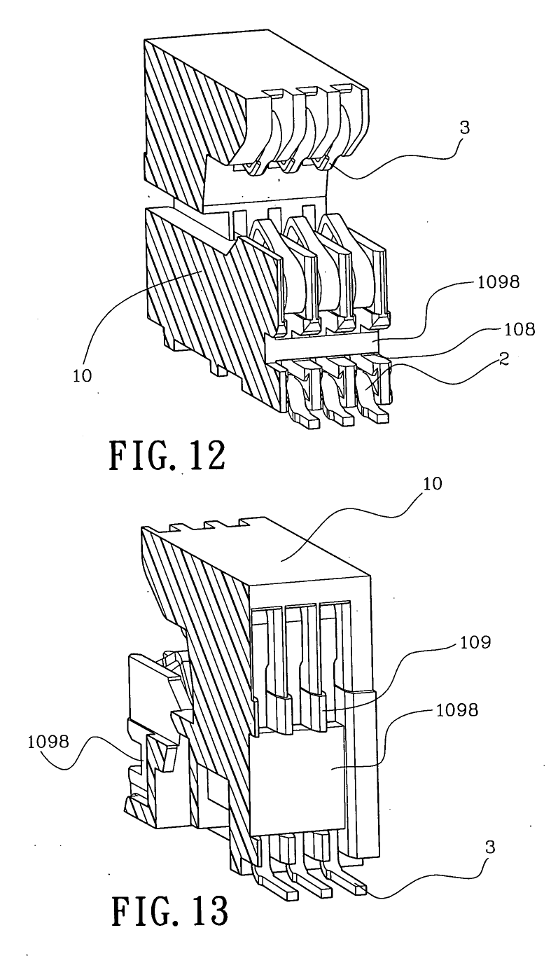

Please refer to FIGS. 5 to 7. The insulating body 10 includes a lengthwise base 11, and plastic buckling arms 12 are provided at both ends of the base 11. The plastic buckling arms 12 and the base 11 are integrally formed into a unit. One side of the base 11 is provided with a lengthwise slot 13 along the longitudinal direction of the base 11. The slot 13 allows an electric card 8 to be inserted therein (as shown in FIGS. 9 and 10). One side of the insulating body 10 is provided with two rows of slug holes 16, 17. The slug holes 16, 17 can reduce the warping and deformation caused by the excessive thickness of the plastic insulating body 10 during its formation. The side of the base 11 of the insulating body 10 on which the slot 13 is provided is defined as the front surface 110, while the side of the insulating body 10 opposite to the above-mentioned front surface 110 is defined as the rear surface 112. Furthermore, the side of the insulating body 10 on which the two rows of slug holes 16, 17 are provided is defined as the bottom surface 111. The bottom surface of the base 11 is the same as the bottom surface of the insulating body 10. That is, the bottom surface 111 of the base 11, the front surface 122 of the plastic buckling arm 12, and the front surface 110 of the insulating body 10 are located on the same side, while the rear surface 123 of the plastic buckling arm 12 and the rear surface 112 of the insulating body 10 are located on the same side. The plastic buckling arm 12 is provided with an accommodating space 121 for accommodating the metallic latch 4. The accommodating space 121 extends from the front surface 122 to the rear surface 123 of the plastic buckling arm 12 and penetrates the insulating body 10. The upper and lower sides of the slot 13 are provided with a plurality of receiving grooves 104, 105 respectively. The upper row of conductive terminals 3 and the lower row of conductive terminals 2 are received in the receiving grooves 104, 105 respectively. Each of the receiving grooves 104, 105 respectively includes a horizontal positioning groove 106, 107 for positioning the conductive terminals (as shown in FIG. 8). The horizontal positioning grooves 106, 107 are located on two diagonal sides of the insulating body 10. On the front surface 110 and rear surface 112 of the insulating body, the receiving grooves 104, 105 on the upper and lower sides are provided with separating ribs 108, 109 that protrude into the first connecting portion of the conductive terminals when the conductive terminals are provided in the insulating body. The construction of the separating ribs 108, 109 can be seen in FIGS. 11 to 13 more clearly. The bottom surface 111 of the base 11 is provided with positioning posts 15. When the slot connector 1 is connected with a docking circuit board (not shown), the positioning posts 15 are provided in corresponding positioning holes on the circuit board, thereby positioning the slot connector 1 on the circuit board. The top of the slug hole 16 is provided with a stopper 161 (See FIG. 8) for stopping a first abutting portion 23 of the lower row of conductive terminals 2. The slug hole 16 is in communication with the receiving groove 105 on the lower side of the insulating body. The slug hole 16 is in communication with the receiving groove 105 to form a yielding space 171. The yielding space 171 provides a sufficient space for the elastic deformation of the lower row of conductive terminals 2 (FIG. 8).

Please refer to FIGS. 8 to 10. The upper row of conductive terminals 3 and the lower row of conductive terminals 2 are received respectively in the receiving grooves 104, 105 on the upper and lower sides of the insulating body (Please see FIG. 7 for receiving grooves 104, 105). The upper row of conductive terminals 3 and the lower row of conductive terminals 2 are provided with contacting portions 31, 21 adjacent to the center of the slot 13 respectively. The contacting portions 31 and 21 face each other but are not located on the same vertical line (e.g. the contacting portions 31 and 21 face each other and are staggered in parallel). The contacting portions 31 and 21 are used to electrically connect to conductive pads (not shown) on both sides of the electric card. The two contacting portions 31 and 21 extend to form a second connecting portion 32, 22 along the inside of the slot 13 respectively. The second connecting portion 32, 22 extends at the end away from the contacting portion 31, 21 to form a first abutting portion 33, 23 respectively. Before the electric card 8 is inserted into the slot 13, the first abutting portion 33, 23 abuts a stopper 101 inside the slot 13 of the insulating body 10 and the stopper 161 on the lower side of the slot 13 respectively. The first abutting portion 33, 23 of each conductive terminal abuts the stopper 101, 161 after being compressed to a certain degree. Since the conductive terminals have elasticity and tend to recover its original state, the first abutting portion 33, 23 of each conductive terminal abuts the stopper 101, 161 tightly before the electric card 8 is inserted into the slot 13, so that each of the conductive terminals is kept in the insulating body and thus subjected to the same preload. The two contacting portions 31, 21 are provided with an outwards-inclining guiding portion 34, 24 along an opening of the slot 13 respectively. The two guiding portions 34 and 24 form an opening 5 with a gradually increasing width for guiding the electric card. The two guiding portions 34, 24 extend to form a bending portion 35, 25 respectively toward the upper and lower sides of the slot. The bending portion 35 on the upper row of conductive terminals 3 is bent upwards and then folded inversely to form an elastic arm 36 that is located above the contacting portions 31 of the upper row of conductive terminal 3. The bending portion 25 on the lower row of conductive terminals 2 is bent downwards and then folded inwards inversely to form an elastic arm 26 that is located obliquely below the contacting portion 21 of the lower row of conductive terminals 2. Of course, the elastic arm 26 of the lower row of conductive terminals 2 can be provided directly below (e.g. not obliquely) its contacting portion 21 (not shown). The elastic arm 36 of the upper row of conductive terminals 3 extends to form a positioning portion 37 that is located in the horizontal positioning groove 106 on the upper side of the insulating body 10. The positioning portion 37 is bent downwards to form a first connecting portion 38 that is perpendicular to the longitudinal direction of the insulating body 10 with one side being adhered to the insulating body 10. The distal end of the first connecting portion 38 extends outwards to form a horizontal soldering portion 39 for soldering the slot connector 1 to a circuit board (not shown). The elastic arm 26 of the lower row of conductive terminals 2 is bent downwards to form another first connecting portion 28 that is perpendicular to the longitudinal direction of the insulating body 10 with one side being adhered to the insulating body 10. The first connecting portion 28 is bent outwards to form a positioning portion 27 that is located in the horizontal positioning groove 107 on the lower side of the insulating body 10. The positioning portion 27 extends outwards to form a horizontal soldering portion 29 for soldering the slot connector 21 to a circuit board (not shown).

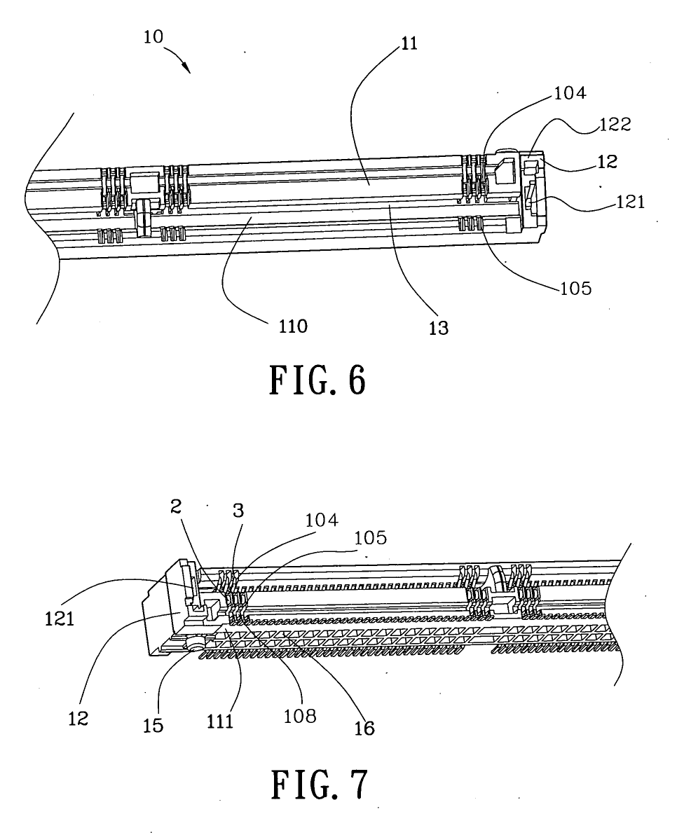

Please refer FIGS. 11 to 13. After the upper row of conductive terminals 3 and the lower row of conductive terminals 2 are assembled in the receiving grooves 104, 105 (see FIGS. 6 to 8 for receiving grooves 104, 105) of the insulating body 10, in order to secure the conductive terminals into the insulating body 10 more efficiently, a tool (not shown) can be used to compress the separating ribs 108, 109 between the adjacent receiving grooves 104, 105, so that the compressed portion of the separating ribs 108, 109 are softened to flow into the receiving grooves 104, 105. Then, the compressed portion of the separating ribs 108, 109 will be deformed to form a holding block 1098 for covering at least a portion of the first connecting portion 38, 28. As a result, a portion of the first connecting portion 38, 28 is covered in the insulating body 10.

Please refer to FIGS. 9 and 10. When the electric card 8 is inserted into the slot connector 1, the electric card 8 is obliquely disposed in the opening 5 formed between the two guiding portions 34 and 24 with a gradually increasing width (see FIG. 8 for opening 5). Then, the electric card 8 is pushed inwards. At this time, the two guiding portions 34 and 24 allow the electric card 8 to be introduced into the slot 13. The electric card 8 are brought into contact with the contacting portions 31, 21 on the upper and lower rows of conductive terminals 3, 2, so that the upper and lower rows of conductive terminals 3, 2 are compressed to deform its elastic arm 36, 26 respectively. The insulating body 10 is provided with a space 102 in the acting direction (perpendicular to the longitudinal direction of the insulating body 10) of the upper and lower rows of conductive terminals 3, 2. When the conductive terminals are compressed to get deformed, the elastic arms 36, 26 generate elastic deformation in the space 102. The upper side of the space 102 of the upper row of conductive terminals 3 is provided with a first abutting block 103 (as shown in FIGS. 9 and 10). When the upper row of conductive terminals 3 is subjected to a larger pressure, it abuts the first abutting block 103. The bending portion 35 and the guiding portion 34 can be still compressed further to generate an elastic deformation. After the electric card 8 is inserted into the slot 13 completely, the elastic arms 36, 26 on the upper and lower rows of conductive terminals 3, 2 can be compressed by the electric card 8 to generate elastic deformation in the space 102 first. After the electric card 8 is inserted into the slot 13 completely and is fixed thereto, the elastic arm 36 on the upper row of conductive terminals 3 partially abuts the first abutting block 103, while the elastic arm 26 on the lower row of conductive terminals 2 does not abut any parts and is located in a corresponding space 102. In this way, when the electric card 8 is inserted, the lower row of conductive terminals 2 will be kept into elastic and compressive contact with the electric card 8 continuously. Further, when the upper row of conductive terminals 3 abut the first abutting block 103, the bending portion 35 and the guiding portion 34 can be still compressed to generate elastic deformation, so that the upper row of conductive terminals 3 are also kept into elastic and compressive contact with the electric card 8. As a result, the contacting portions 31, 21 of the upper and lower rows of conductive terminals 3, 2 are brought into tight contact with the electric card 8.

Since the bending portion 35, 25 folds inversely to form the elastic arms 36, 26, the conductive terminals can provide a better elasticity when compressed. The two contacting portions 31, 21 extend to form a second connecting portion 32, 22 along the inside of the slot 13 respectively. Therefore, the distal ends of the two contacting portions 31, 21 of the conductive terminals extend toward the inside of the slot 13, so that the extending direction of the terminals is the same as the insertion direction of the electric card 8, thereby avoiding the snap of terminals caused by the unbalanced force or improper insertion angle upon the insertion of the electric card 8.

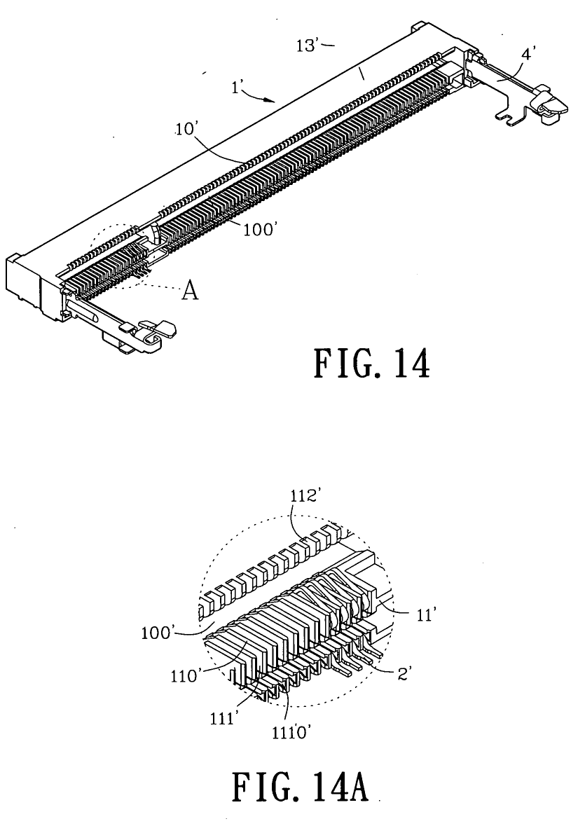

Please refer to FIGS. 14 to 19, which show the second embodiment of the present invention.

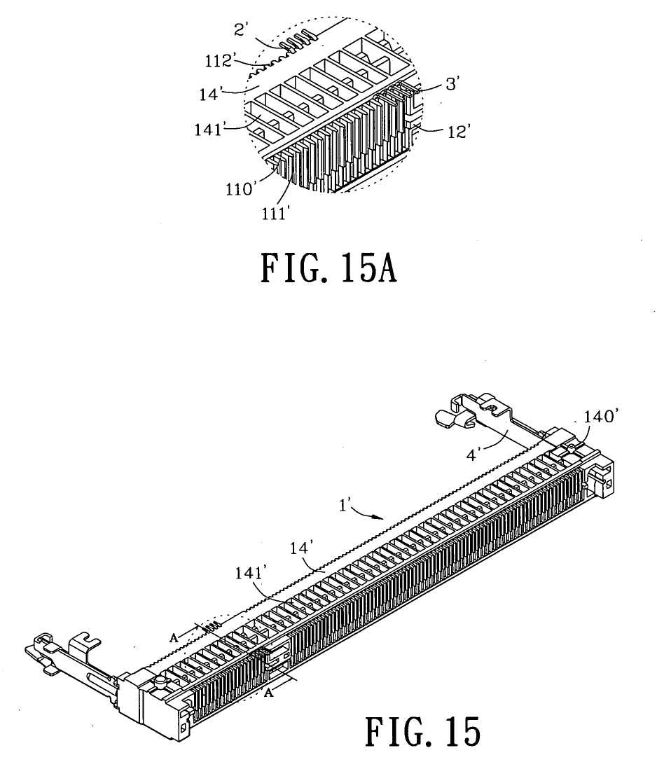

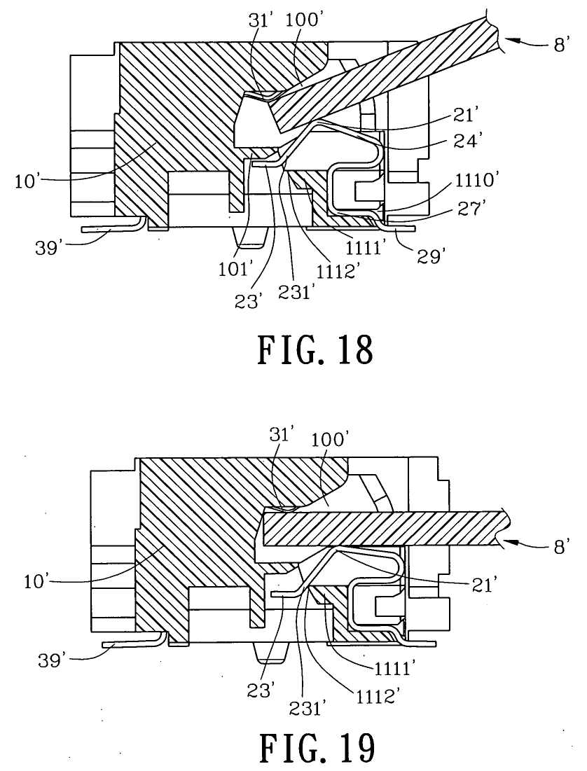

Please refer to FIGS. 14, 14A, 15 and 15A, which are schematic views showing the entirety of the slot connector 1′ of the present invention. Therein, the symbol A in FIGS. 14 and 15 simply indicate the location for cross-sectional magnification of the slot connector 1′ as represented by FIGS. 14A and 15A respectively. The slot connector 1′ is used to electrically connect an electric card 8′ (as shown in FIGS. 18 and 19) to a circuit board (not shown), which includes an insulating body 10′, an upper row of conductive terminals 3′, a lower row of conductive terminals 2′, and a set of metallic latches 4′.

The insulating body 10′ is lengthwise and is provided therein with a lengthwise slot 100′. The upper row of conductive terminals 3′ and the lower row of conductive terminals 2′ are staggered on both sides of the slot 100′. The lower row of conductive terminals 2′ are provided on the lower side of the slot 100′, while the upper row of the conductive terminals 3′ are provided on the upper side of the slot 100′.

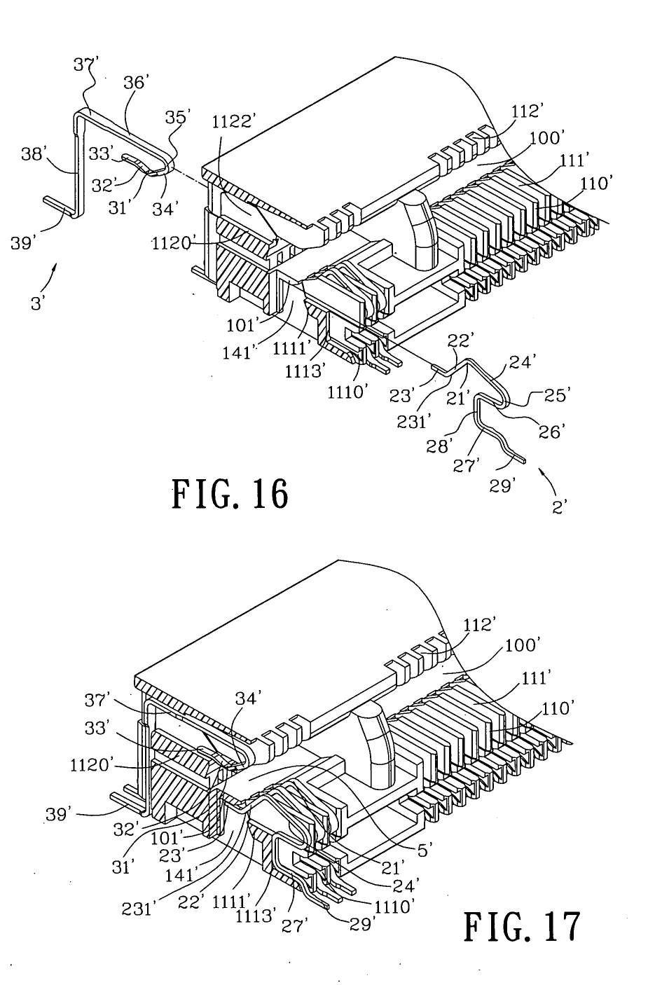

Please refer to FIGS. 14, 14A, 15, 15A in conjunction with FIGS. 16 and 17. The insulating body 10′ includes a front wall 11′, a rear wall 12′ opposite to the front wall 11′, a top wall 13′, and a bottom wall 14′. The slot 100′ is recessed from the front wall 111′ for allowing the electric card 8′ to be inserted therein (as shown in FIGS. 18 and 19). Both sides of the slot 100′ are provided with a plurality of separating ribs 110′ perpendicular to the slot 100′. A plurality of receiving grooves 111′ is formed between two adjacent separating ribs 110′ on the lower side for receiving the lower row of conductive terminals 2′. The receiving groove 111′ includes a horizontal positioning groove 1110′ and a first abutting wall 1113′ connected to the horizontal positioning groove 1110′. The horizontal positioning groove 1110′ is perpendicular to the separating ribs 110′. A second abutting block 1111′ extends from the first abutting wall 1113′ to the inside of the insulating body. The distal end of the second abutting block 1111′ forms a horn-like abutting portion. 1112′ (See FIGS. 18 and 19 for abutting portion 1112′). One inner side of the first receiving groove 111′ opposing to the second abutting block 1111′ is provided with a stopping block 101′ that is located higher than the second abutting block 1111′. After the lower row of conductive terminals 2 are assembled in the insulating body 10′, the stopping block 101′ can prevent the terminals from inserting into the slot 100′ excessively and can allow the lower row of conductive terminals 2 to be received in the insulating body 10′ firmly.

The rear wall 12′ is recessed to form a plurality of receiving grooves 112′ for receiving the upper row of conductive terminals 3′. One side of the receiving groove 112′ adjacent to the rear wall 12′ of the insulating body 10′ is also formed by the separation of two adjacent separating ribs 110′ on this side, and it is located on the upper side of the slot 100′. The receiving groove 111′ for receiving the lower row of conductive terminals 2′ and the receiving groove 112′ for receiving the upper row of conductive terminals 3′ are staggered. The receiving groove 112′ is provided therein with a third abutting block 1120′. One side of the receiving groove 112′ adjacent to the rear wall 12′ is provided with a horizontal positioning groove 1122′ for positioning the upper row of conductive terminals 3′. The horizontal positioning groove 1122′ is perpendicular to the separating ribs 110′.

The bottom wall 14′ is provided with two positioning posts 140′. The bottom wall 14′ is recessed to form a plurality of slug grooves 141′ for reducing the warping and deformation caused by the excessive thickness during the formation of the insulating body 10′. The slug groove 141′ is in communication with the receiving groove 111′. When the lower row of conductive terminals 2′ received in the receiving groove 111′ are compressed to generate elastic deformation or a movement, the terminals can extend in the slug groove 141′. Therefore, the slug groove 141′ also acts as a yielding space (similar to the yielding space 171 of FIGS. 8 and 9) to allow for the elastic deformation or movement of the lower row of conductive terminals 2′.

Please refer to FIGS. 16 and 17. The upper row of conductive terminals 3′ and the lower row of conductive terminals 2′ are received in the receiving grooves 111′, 112′ on the upper and lower sides of the insulating body respectively. The upper row of conductive terminals 3′ and the lower row of conductive terminals 2′ are provided with contacting portions 31′ and 21′ adjacent to the center of the slot 100′ respectively. The contacting portions 31′ and 21′ face each other but they are not located on the same vertical line (e.g. contacting portions 31′, 21′ face each other and are staggered in parallel). The contacting portions 31′ and 21′ are used to electrically connect to conductive pads (not shown) on both sides of the electric card 8′. The two contacting portions 31′, 21′ extend to form a second connecting portion 32′, 22′ along the inside of the slot 100′ respectively. The second connecting portion 32′, 22′ extends to form a first abutting portion 33′, 23′ respectively at the end away from the contacting portion 31′, 21′. Before the electric card 8′ is inserted into the slot 100′, the first abutting portions 33′ and 23′ respectively abut the third abutting block 1120′ and the stopping block 101′ inside the slot 100′ of the insulating body 10′, so that the upper and lower rows of conductive terminals 3′, 2′ can be held in the receiving grooves 111′ and 112′ more firmly. After the first abutting portions 33′ and 23′ of each conductive terminal are compressed to a certain degree, they abut on the third abutting block 1120′ and the stopping block 101′ respectively. Since the conductive terminals have elasticity and tend to return to its original state, the first abutting portion 33′, 23′ of each conductive terminal will tightly abut on the third abutting block 1120′ and the stopping block 101′ respectively before the insertion of the electric card 8′, thereby keeping each conductive terminal in the insulating body 10′. The lower row of conductive terminals 2′ extend from the corresponding contacting portion 21′ to form a second abutting portion 231′ along the inside of the slot 100′. The second abutting portion 231′ is provided on the side opposite to the contacting surface between the contacting portion 21′ and the electric card 8′. The two contacting portions 31′, 21′ are provided with an outwards-inclining guiding portion 34′, 24′ respectively along the opening of the slot 100′. The two guiding portions 34′, 24′ form an opening 5′ with a gradually increasing width for guiding the electric card 8′. The two guiding portions 34′, 24′ are bent to form a bending portion 35′, 25′ toward the upper and lower sides of the slot 100′ respectively. The bending portion 35′ on the upper row of conductive terminals 3′ is bent upwards and then folded inversely to form an elastic arm 36′ located above the contacting portion 31′ of the upper row of conductive terminals 3′. The bending portion 25′ on the lower row of conductive terminals 2′ is bent downwards and then folded inwards inversely to form an elastic arm 26′ located obliquely below the contacting portion 21′ of the lower row of conductive terminals 2′. The elastic arm 36′ on the upper row of conductive terminals 3′ extends to form a positioning portion 37′ that is located in the horizontal positioning groove 1122′ on the upper side of the insulating body 10′. The positioning portion 37′ is bent downwards to form a first connecting portion 38′ that is perpendicular to the longitudinal direction of the insulating body 10′ with one side being adhered to the insulating body 10′. The distal end of the first connecting portion 38′ extends outwards to form a horizontal soldering portion 39′. The elastic arm 26′ of the lower row of conductive terminals 2′ is bent downwards to form another first connecting portion 28′. The first connecting portion 28′ is bent outwards to form a positioning portion 27′ that is located in the horizontal positioning groove 1110′ on the lower side of the insulating body 10′. The positioning portion 27′ extends outwards to form a horizontal soldering portion 29′.

Please refer to FIGS. 16 and 17. The assembling procedure of the slot connector 1′ is as follows. First, the lower row of conductive terminals 2′ are inserted into the receiving groove 111′, so that the first abutting portion 23′ is restricted below the stopping block 101′. The positioning portion 27′ is received in the horizontal positioning groove 1110′. Finally, the first connecting portion 28′ abuts on the first abutting wall 1113′. The soldering portion 29′ is exposed to the outside of the receiving groove 111′. The upper row of conductive terminals 3′ are inserted into the receiving groove 112′ in a direction extending from the rear wall 12′ to the front wall 11′ of the insulating body 10′, so that the first abutting portion 33′ abuts on the third abutting block 1120′. The positioning portion 37′ is located in the horizontal positioning groove 1122′. One side of the first connecting portion 38′ is adhered to the insulating body 10′. The soldering portion 39′ is exposed to the outside of the receiving groove 112′. At this time, it can been clearly seen that the separating ribs 110′ protrude from the first connecting portion 38′, 28′ of the upper and lower rows of conductive terminals 3′, 2′. Then, the metallic latches 4′ are assembled at both ends of the insulating body 10′. In order to secure the conductive terminals into the insulating body 10′ more efficiently, like the first embodiment, a tool (not shown) can be used to compress the separating ribs 110′ between the adjacent receiving grooves 111′, 1112′, so that the compressed portion of the separating ribs 110′ is softened to flow into the receiving grooves 111′, 1112′. Then, the compressed portion of the separating ribs 110′ will be deformed to form a holding block for covering at least a portion of the first connecting portion 38′, 28′. In the present embodiment, the deformed separating ribs 110′ is not shown, but the principle thereof is identical to that of the holding block 1098 first embodiment.

Please refer to FIGS. 15, 18, and 19. In use, the positioning posts 140′ of the slot connector 1′ are inserted into positioning holes (not shown) of a circuit board (not shown), thereby assembling the slot connector 1′ to a predetermined position on the circuit board. Then, the soldering portions 39′, 29′ are soldered to the circuit board (not shown). Thereafter, the electric card 8′ is obliquely inserted into the slot 100′ via the opening 5′ of the slot 100′, so that electrical conductive pads (not shown) on both side surfaces of the electric card 8′ can be brought into contact with the contacting portions 31′, 21′. Then, the electric card 8′ is pushed inwards until it reaches the bottom of the slot 100′. Finally, the electric card 8′ is pressed toward the circuit board (not shown), so that the electric card 8′ is substantially parallel to the plane of the circuit board.

When the electric card 8′ is pressed toward the circuit board (not shown), since the contacting portion 21′ of the lower row of conductive terminals 2′ are compressed by the electric card 8′, they will move downwards with the pressing of the electric card 8′. At the same time, the elastic arm 26′ will generate a downward elastic deformation. The second abutting portion 231′ also moves downwards to finally abut on the abutting portion 1112′ of the second abutting block 1111′. When the electric card 8′ is compressed downwards further, the second abutting portion 231′ will continue to move obliquely and downwards with respect to the second abutting block 1111′. The abutting portion 1112′ abuts between the top and bottom ends of the second abutting portion 231′, so that the distal end of the second abutting portion 231′ is not restricted. That is, the distal end of the second abutting portion can continue to move downwards, so that all the lower row of conductive terminals 2′ can abut on the abutting portion 1112′ of the second abutting block 1111′. The contacting portion 21′ can be brought into tight contact with the electric card 8′. Therefore, the contact degrees between the electric card 8′ and each contacting portion 21′ are the same, and in turn the impedances among the lower row of conductive terminals 2′ are the same. Thus, the high-frequency property between the conductive terminals 2′ in the lower row will not be affected. Furthermore, during the insertion of the electric card 8′, the lower row of conductive terminals 2′ slide a distance on the electric card 8′. When sliding, the contacting portion 21′ is kept in tight contact with the electric card 8′, so that the oxidation layer on the contacting portion 21′ can be scraped off completely, thereby keeping a good electrical connection between the slot connector 1′ and the electric card 8′.

What is claimed is:

1. A slot connector comprising: a lengthwise insulating body, an upper row of conductive terminals, and a lower row of conductive terminals; the insulating body is provided with a lengthwise slot along its longitudinal direction for receiving an electric card, the upper and lower sides of the slot are provided with a plurality of receiving grooves for receiving the upper and lower rows of conductive terminals respectively; the upper and lower rows of conductive terminals are provided with contacting portions that respectively face to each other but are not located on the same vertical line; the two contacting portions are provided along an opening of the slot with an outwards-inclining guiding portion respectively, the two guiding portions form an opening with a gradually increasing width for guiding the electric card; the two guiding portions are provided with a bending portion respectively, at least one bending portion extends inversely to form an elastic arm; and the elastic arm is bent and extended to form a first connecting portion perpendicular to the longitudinal direction of the insulating body, the end of the first connecting portion away from the elastic arm is provided with a soldering portion, the two contacting portions are provided with a second connecting portion along the inside of the slot respectively.

2. The slot connector according to claim 1, wherein the insulating body is provided with a space and a first abutting block in an acting direction of at least one conductive terminal, the bending portion and the guiding portion are still compressed to generate elastic deformation when the conductive terminals abut the first abutting block.

3. The slot connector according to claim 1, wherein both sides of the insulating body are provided with a horizontal positioning groove respectively for positioning the upper and lower rows of conductive terminals.

4. The slot connector according to claim 1, wherein the two bending portions are folded inversely to form an elastic arm respectively, at least one elastic arm is bent to form a first connecting portion with its one side being adhered to the insulating body.

5. The slot connector according to claim 4, wherein at least a portion of the first connecting portion is covered in the insulating body.

6. The slot connector according to claim 1, wherein the insulating body is provided with a separating rib protruding from the first connecting portion of the conductive terminals, at least a portion of the separating rib is deformed to form a holding block for covering at least a portion of the first connecting portion.

7. The slot connector according to claim 1, wherein the second connecting portion extends at the end away from the contacting portion to form a first abutting portion for abutting on the insulating body.

8. A slot connector comprising: a lengthwise insulating body, an upper row of conductive terminals, and a lower row of conductive terminals; the insulating body is provided with a lengthwise slot along its longitudinal direction for receiving an electric card, the upper and lower sides of the slot are provided with a plurality of receiving grooves for receiving the upper and lower rows of conductive terminals respectively; at least one receiving groove receiving the lower row of conductive terminals is provided with a second abutting block, the upper and lower rows of conductive terminals are provided with contacting portions that respectively face each other but are not located on the same vertical line; the two contacting portions are provided along an opening of the slot with an outwards-inclining guiding portion respectively, the two guiding portions form an opening with a gradually increasing width for guiding the electric card; the two guiding portions are provided with a bending portion respectively, the lower row of conductive terminals extends from the corresponding contacting portion along the inside of the slot to form a second abutting portion, the second abutting portion is provided on the side opposite to the contacting surface between the contacting portion and the electric card; when the contacting portions of the lower row of conductive terminals are pressed, the second abutting portion abuts the second abutting block of the insulating body and slides with respect to the second abutting block.

9. The slot connector according to claim 8, wherein the second abutting portion moves downwards and obliquely with respect to the second abutting block.

10. The slot connector according to claim 8, wherein the insulating body is provided with a space and a first abutting block in an acting direction of at least one conductive terminal, the bending portion and the guiding portion of the conductive terminals are still compressed to generate elastic deformation when the conductive terminals abut the first abutting block.

11. The slot connector according to claim 8, wherein the two bending portions are folded inversely to form an elastic arm respectively, at least one elastic arm is bent to form a first connecting portion with its one side being adhered to the insulating body.

12. The slot connector according to claim 8, wherein two diagonal sides of the insulating body are provided with a horizontal positioning groove respectively for positioning the upper and lower rows of conductive terminals.

13. The slot connector according to claim 12, wherein the bending portion of the upper row of conductive terminals is bent upwards and then folded inversely to form an elastic arm located above the contacting portion of the upper row of conductive terminals, the bending portion of the lower row of conductive terminals is bent downwards and then folded inwards inversely to form an elastic arm located obliquely below the contacting portion of the lower row of conductive terminals, the elastic arm of the upper row of conductive terminals extends to form a positioning portion located in the horizontal positioning groove on the upper side of the insulating body, the positioning portion is bent downwards to form a first connecting portion, the distal end of the first connecting portion extends outwards to form a horizontal soldering portion, the elastic arm of the lower row of conductive terminals is bent downwards to form another first connecting portion, the another first connecting portion is bent outwards to form a positioning portion located in the horizontal positioning groove on the lower side of the insulating body, the positioning portion extends outwards to form a horizontal soldering portion.

14. The slot connector according to claim 13, wherein both sides of the insulating body are provided with a separating rib respectively for protruding from the first connecting portion of the conductive terminals, and the horizontal positioning groove is perpendicular to the separating ribs.

15. The slot connector according to claim 13, wherein the insulating body is provided with a separating rib protruding from the first connecting portion of the conductive terminals, at least a portion of the separating rib is deformed to form a holding block for covering at least a portion of the first connecting portion.

16. A slot connector comprising: a lengthwise insulating body, an upper row of conductive terminals, and a lower row of conductive terminals; the insulating body is provided with a lengthwise slot along its longitudinal direction for receiving an electric card, the upper and lower sides of the slot are provided with a plurality of receiving grooves for receiving the upper and lower rows of conductive terminals respectively; the upper and lower rows of conductive terminals are provided with contacting portions that respectively face each other but are not located on the same vertical line; the two contacting portions are provided along the inside of the slot with a first abutting portion respectively for abutting the insulating body; and the contacting portion of the lower row of conductive terminals extends to form a bending portion, the bending portion extends to form a horizontal positioning portion.

17. The slot connector according to claim 16, wherein the two contacting portions are provided along the opening of the slot with an outwards-inclining guiding portion respectively, the two guiding portions form an opening with a gradually increasing width for guiding an electric card.

18. The slot connector according to claim 17, wherein two diagonal sides of the insulating body are provided with a horizontal positioning groove respectively for positioning the conductive terminals, the two guiding portions of the two rows of conductive terminals extend to form a bending portion respectively, the bending portion of the upper row of conductive terminals is bent upwardly and then folded inversely to form an elastic arm located above the contacting portion of the upper row of conductive terminal, the bending portion of the lower row of conductive terminals is bent downwards and then folded inwards inversely to form an elastic arm located obliquely below the contacting portion of the lower row of conductive terminals; the elastic arm of the upper row of conductive terminals extends to form a positioning portion located in the horizontal positioning groove on the upper side of the insulating body, the positioning portion is bent downwards to form a first connecting portion, the distal end of the first connecting portion extends outwards to form a horizontal soldering portion; the elastic arm of the lower row of conductive terminals is bent downwards to form another first connecting portion, the another first connecting portion is bent outwards to form a positioning portion located in the horizontal positioning groove on the lower side of the insulating body, the positioning portion extends outwards to form a horizontal soldering portion.

19. The slot connector according to claim 18, wherein at least a portion of the first connecting portion is covered in the insulating body.

20. The slot connector according to claim 18, wherein the insulating body is provided with a separating rib protruding from the first connecting portion of the conductive terminals, at least a portion of the separating rib is deformed to form a holding block for covering at least a portion of the first connecting portion.
